(19) United States
(12) Patent Application Publication
(10) Pub. No.: US 2008/0195430 A1
(43) Pub. Date: Aug. 14, 2008

(54) DATA QUALITY MEASUREMENT FOR ETL PROCESSES

(75) Inventor: Amit Rustagi, San Jose, CA (US)

Correspondence Address: BEYER LAW GROUP LLP/YAHOO, PO BOX 1687, CUPERTINO, CA, 95015-1687, US

(73) Assignee: YAHOO! INC., Sunnyvale, CA (US)

(21) Appl. No.: 11/673,690

(22) Filed: Feb. 12, 2007

(51) Int. Cl. G06N 5/02; G06Q 10/00

(52) U.S. Cl. 705/7; 706/47

(57) ABSTRACT

Techniques for maintaining data quality of transformed data generated using an Extract-Transform-Load (ETL) process and stored in at least one data warehouse, the method comprising generating a quality metric for each of a plurality of units of the transformed data with reference to at least one data quality measurement rule, the quality metric for each unit of the transformed data representing a validity measure defined by the corresponding data quality measurement rule; and generating a report organizing the quality metrics for selected units of the transformed data.

### BACKGROUND OF THE INVENTION

1. Field of the Invention

The present invention relates to determining and reporting data quality for the data stored in the data warehouses within the framework of the Extract-Transform-Load (ETL) processes.

2. Background of the Invention

Extract, transform, and load (ETL) is a data warehousing process that involves three steps: (1) extracting data from one or more data sources; (2) transforming the extracted data to fit various business needs; and (3) loading the transformed data into one or more data warehouses. Often, businesses have valuable data scattered throughout their networks, databases, business applications, etc. It would be difficult to analyze these data and obtain meaningful results unless these data are cleansed, formatted, and centralized. The ETL process provides a solution to this problem by extracting the relevant data from all types of sources, cleansing, formatting, and organizing the data according to the specific requirements of a particular business, and loading the processed data into a central repository, such as a data warehouse or a database. Thereafter, the data may be analyzed in parts or as a whole to provide various types of useful information to the business. Reports may be generated based on the results of the analysis.

In order for the data analysis to yield correct results, the data being analyzed need to be of sufficiently good quality. This means that the data extracted from the original data sources during the ETL process need to be sufficiently free of errors. Obviously, analyzing erroneous data generally leads to erroneous and thus, misleading and useless results.

Existing ETL processes do not provide any means of monitoring the quality of the data being extracted from the data sources to ensure that only correct data are loaded into the warehouses for analysis. Instead, all extracted data, whether they are good or bad and whether they contain errors or not, are transformed and loaded into the data warehouses. Thereafter, when these data are analyzed, there is no way of indicating whether the data being analyzed are correct or not, which means that there is no way of ensuring that the results of the analysis are correct.

Accordingly, what is needed are systems and methods for monitoring and maintaining the quality of data loaded into data warehouses during ETL processes.

### SUMMARY OF THE INVENTION

Broadly speaking, the present invention relates to maintaining the quality of data loaded and stored in data warehouses during ETL processes.

In one embodiment, a computer-implemented method for maintaining data quality of transformed data generated using an Extract-Transform-Load (ETL) process and stored in at least one data warehouse is described. The method comprises generating a quality metric for each of a plurality of units of the transformed data with reference to at least one data quality measurement rule, the quality metric for each unit of the transformed data representing a validity measure defined by the corresponding data quality measurement rule; and generating a report organizing the quality metrics for the transformed data. Optionally, the method further comprises alerting a user when at least one quality metric is not within a corresponding error tolerance defined by the corresponding data quality measurement rule.

In another embodiment, a system for maintaining data quality of transformed data generated using an ETL process is described. The system comprises at least one data warehouse configured to store the transformed data, a repository linked with each of the at least one data warehouse configured to store at least one data quality measurement rule and quality metrics, and a reporting mechanism linked with the repository configured to generate a report organizing the at least one quality metric for the transformed data. Each quality metric stored in the repository represents a validity measure defined by the corresponding data quality measurement rule for each of a plurality of units of the transformed data. Optionally, the system further comprises an alerting mechanism linked with the repository configured to alert a user when at least one quality metric is not within a corresponding error tolerance defined by the corresponding data quality measurement rule.

In another embodiment, a computer program product for maintaining data quality of transformed data generated using an ETL process and stored in at least one data warehouse is described. The computer program product comprises a computer-readable medium having a plurality of computer program instructions stored therein, which are operable to cause at least one computer device to generate a quality metric for each of a plurality of units of the transformed data with reference to at least one data quality measurement rule, the quality metric for each unit of the transformed data representing a validity measure defined by the corresponding data quality measurement rule; and generate a report organizing the quality metrics for the transformed data. Optionally, the computer program product further comprises computer instructions to alert a user when at least one quality metric is not within a corresponding error tolerance defined by the corresponding data quality measurement rule.

These and other features, aspects, and advantages of the invention will be described in more detail below in the detailed description and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 (prior art) illustrates an example of a typical ETL process.

FIG. 2 is a block diagram illustrating an example of a system that maintains the data quality of the data stored in one or more data warehouses within the framework of ETL processes.

FIG. 3 is a flowchart of a method for maintaining the data quality of the data stored in one or more data warehouses within the framework of ETL processes.

FIG. 4 is a flowchart of a method for updating the data quality measurement rules in accordance with a specific embodiment of the invention.

FIG. 5 is a simplified diagram of a network environment in which specific embodiments of the present invention may be implemented.

### DETAILED DESCRIPTION OF THE INVENTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. In addition, while the invention will be described in conjunction with the particular embodiments, it will be understood that it is not intended to limit the invention to the described embodiments. To the contrary, it is intended to cover alternatives, modifications, and equivalents as may be included within the spirit and scope of the invention as defined by the appended claims.

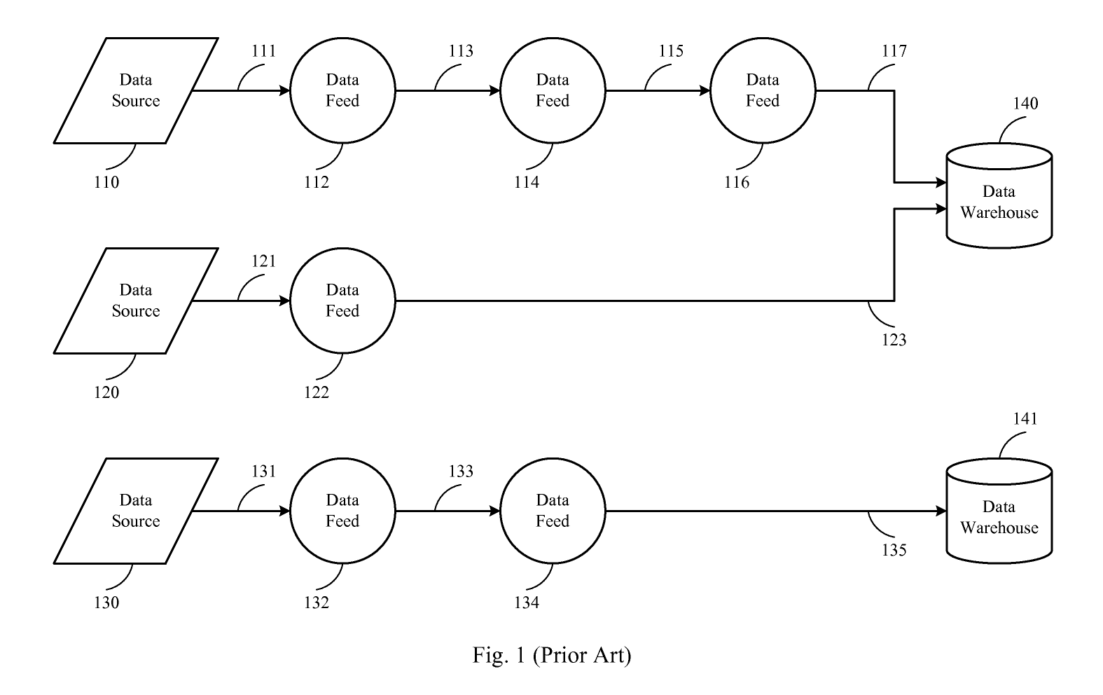

Extract, transform, and load (ETL) is a data warehousing process that consolidates data from multiple sources, and which often stores data in different formats into a centralized repository such as a data warehouse, a data mart, or a database. FIG. 1 illustrates an example of a typical ETL process.

First, data are extracted from one or more sources of various types, such as web logs, mainframe applications, spreadsheets, message queues, etc. By way of illustration, FIG. 1 shows three data sources: Data Source 110, Data Source 120, and Data Source 130. Often, each type of data source organizes and stores data in a different format. In addition, some data are useful while other data are not. For example, a web log generally contains an overwhelming amount of information, some of which may be helpful in planning future marketing strategies while others may not. Therefore, the extracted data need to be cleansed to remove duplicate, irrelevant, or useless data and reformatted so that all data from different types of sources are in the format required by the final repository where the data will be stored ultimately.

Next, during the transform phase, a series of rules or functions are applied to the extracted data to cleanse, reformat, and reorganize the extracted data. Business functions and rules may also be applied to the extracted data. For example, if a particular business is only interested in data regarding those customers residing in the same state where the business is located, a rule may be applied to the extracted data to select only those data relating to the customers-of-interest to the business.

Data transform may be performed in stages. In other words, a set of rules or functions may be applied to the extracted data, followed by another set of rules or functions being applied to the same data. Sometimes, the transformed data are referred to as “data feed.” By way of illustration, FIG. 1 shows that transform for data extracted from Data Source 110 is done in three stages 111, 113, 115, transform for data extracted from Data Source 120 is done in one stage 121, and transform for data extracted from Data Source 130 is done in two stages 131, 133.

For data extracted from Data Source 110, after the first stage transform 111, the extracted data are turned into Data Feed 112. Then, the second stage transform 113 is applied to Data Feed 112 to obtain Data Feed 114. Finally, the third stage transform 115 is applied to Data Feed 114 to obtain Data Feed 116. Each stage of transform applies some rules or functions to the data. For example, the first stage transform 111 may cleanse the raw data extracted from Data Source 110. The second stage transform 113 may summarize the cleansed Data Feed 112 according to some business logic. The third stage transform 115 may reformat the cleansed and summarized Data Feed 114 so that the data are in the correct format to be stored. Thus, Data Feed 116 has cleansed, summarized, and reformatted data, ready to be loaded.

For data extracted from Data Source 120, there is only one stage of transform 121. After the transform process 121, the extracted data from Data Source 120 are turned into Data Feed 122.

For data extracted from Data Source 130, after the first stage transform 131, the extracted data are turned into Data Feed 132. Then, the second stage transform 133 is applied to Data Feed 132 to obtain Data Feed 134.

Last, during the load phase, the transformed data are loaded into one or more data warehouses, data marts, or databases. A data warehouse is a repository of an entity's, such as a corporation or an organization, historical data. A data mart is a specialized version of a data warehouse, which is designed and configured based on specific and predefined needs so that it is especially suitable for certain types of selected data organized in specific groups and configurations. The number of data warehouses used to load and store the data depends on the specific requirements of the individual businesses. For example, if a particular business prefers to have a centralized repository for all of its data, then all data extracted from all sources may be loaded into a single data warehouse. By way of illustration, FIG. 1 shows two data warehouses: Data Warehouse 140 and Data Warehouse 141. Transformed data from Data Source 110 and Data Source 120 are loaded 117, 123 into Data Warehouse 140, while transformed data from Data Source 130 are loaded 135 into Data Warehouse 141.

As shown in FIG. 1, with a typical ETL process, all data extracted from all sources are transformed and loaded into data warehouses. There is no mechanism for determining whether there are errors in the data extracted from any of the data sources. Consequently, there is no guarantee that data loaded into the warehouses are free of errors. Analysis performed on the data loaded into the warehouses may or may not generate correct results, depending on whether or not the data are erroneous.

To remedy this problem, embodiments of the present invention determine and maintain the quality of the data loaded in the data warehouses. In accordance with one embodiment, a set of data quality measurement rules is defined and stored in a central repository. These rules may be defined by the entity, i.e., corporation or organization, whose data are to be warehoused using the ETL process. Different entities often have different quality measurement rules depending on the business requirements of the individual entities. The data quality measurement rules may include specific rules such as acceptable ranges and/or error tolerance levels for each type of data. The rules may be updated as the business requirements of the entities change.

According to a specific embodiment, after the data are extracted, transformed, and loaded into one or more data warehouses at the end of the ETL processes, the predefined data quality measurement rules are applied to the data to determine whether they are within the acceptable ranges or whether the data contain any errors. This quality information may be stored in the central repository along with the data quality measurement rules. One or more reports may also be generated regarding the quality of the data. In addition, if there are significant errors in the data, users may be alerted to correct the causes of the errors.

According to an alternative embodiment, the predefined data quality measurement rules may be applied to the data to determine the qualities of the data before they are loaded into one or more data warehouses, such as applying the rules after the data are extracted or after the data are transformed. In this case, the qualities of the data may be determined before the data are loaded into the data warehouses, and erroneous data may not be stored in the data warehouses at all. However, determining data qualities before data are loaded into the warehouses delays the loading step. While erroneous data may be prevented from loading into the warehouses, the loading of good quality data may be delayed.

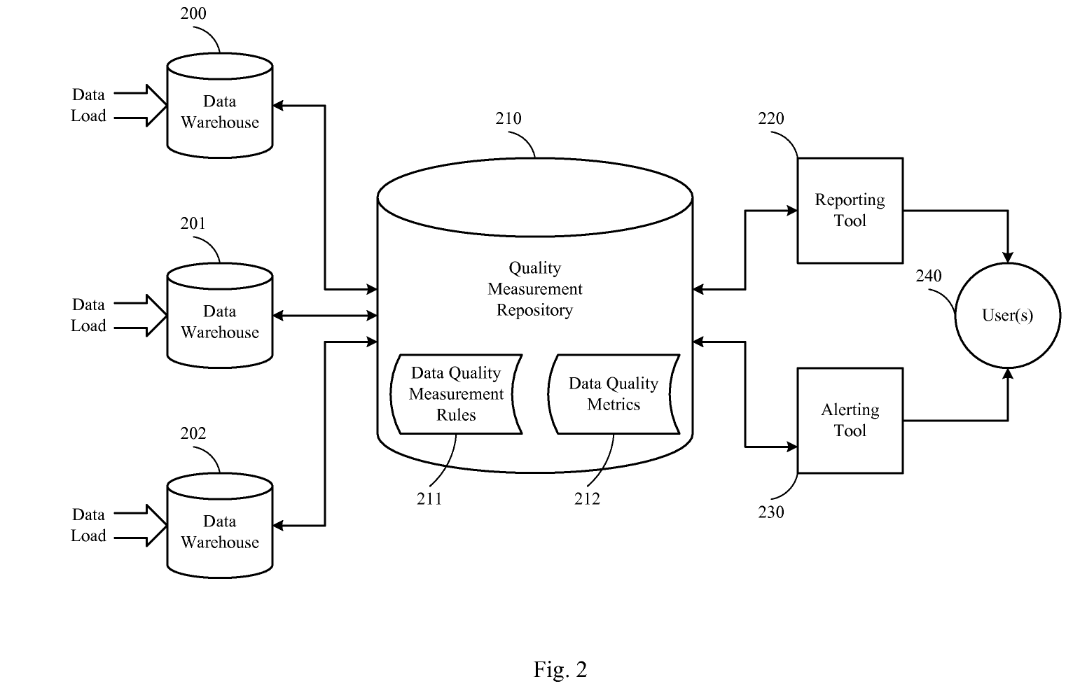

FIG. 2 is a block diagram illustrating an example of a system that maintains the data quality of the data stored in one or more data warehouses within the framework of ETL processes. The system may contain any number of data warehouses, and the same principle applies regardless of the number of data warehouses present in the system. By way of illustration, FIG. 2 shows three data warehouses: Data Warehouse 200, Data Warehouse 201, and Data Warehouse 202. Data are loaded into each of the warehouses 200, 201, 202 at the end of an ETL process, after they have been extracted and transformed.

A Quality Measurement Repository 210 is linked with each of the data warehouses 200, 201, 202. Usually, there is one and only one Quality Measurement Repository 210 present in the entire system. It is the central repository for all the Data Quality Measurement Rules 211 and Data Quality Metrics 212. The Quality Measurement Repository 210 may be some type of database. For example, the Quality Measurement Repository 210 may be a Structured Query language (SQL) based database.

The Data Quality Measurement Rules 211 are predefined by the owner, i.e., corporation or organization, of the system based on the specific business requirements of the owner. The rules 211 may include information such as the standard ranges and error tolerance levels for each type of data. For example, assume the owner of a system is a merchant that sells various products on the Internet through its business website. The data stored in the warehouses 200, 201, 202 are extracted from the web log files of the merchant's website. Typical web log files contain information relating to the status and activities of a website. Often, such information is gathered using cookies or user provided data such as user login or password. Data from web log files may relate to information such as the number of times each product web page is viewed every day (page view number), the number of products sold through the website every month, the number of times each advertisement link is clicked every day (link click number), which user logs onto the website and when, etc. Assume based on past experience, the number of times the web page for a particular product, product X, is viewed approximately 15 to 25 times every day. Then, the merchant may define a rule that specifies that for product X's web page, the daily page view number should be 20, with an error tolerance level of ±5. Subsequently, this rule may be used to determine the quality of the data relating to the daily page view number for product X's web page by applying this rule to the data stored in the data warehouses 200, 201, 202. If the data in the warehouses 200, 201, 202 indicate that the daily page view number for product X's web page is 17 or 22 or any number between 15 and 25, then based on the predefined rule, the quality of the data is good. On the other hand, if the data indicate that the daily page view number for product X's web page is 5 or 50, then the quality of the data is bad and the data are probably erroneous.

Similarly, different rules may be defined for different types of data. For example, one rule may indicate the number of visitors the website has each week, while another rule may specify the number people who actually purchase products from the website each month. Generally, a data quality measurement rule is defined for each type of data stored in the data warehouses 200, 201, 202 for which quality is to be measured. And all defined data quality measurement rules are stored in the Quality Measurement Repository 210. The actual data format used to store the Data Quality Measurement Rules 211 depends on the type of database used for the Quality Measurement Repository 210. For example, if the Quality Measurement Repository 210 is an SQL-based database, then the Data Quality Measurement Rules 211 may be defined using SQL-based language as well. These SQL-based rules 211 are then applied to the data stored in the data warehouses 200, 201, 202.

The Data Quality Measurement Rules 211 may be updated either periodically or as the need arises. In the above example, assume the merchant's business increases steadily as time passes. As a result, more and more people visit its website, and the daily page view number for product X's web page has increased to 50 to 70 times. The merchant may update the rule for the daily page view number for product X's web page to 60, with an error tolerance level of ±10. The new rule is again stored in the Quality Measurement Repository 210 and subsequently applied to the data loaded into the data warehouses 200, 201, 202 along with other rules to determine the quality of the data stored therein.

The quality of the data stored in the data warehouses 200, 201, 202 is determined by applying the predefined Data Quality Measurement Rules 211 to the data. If the data are within the specified error tolerance levels, then their quality is good. Otherwise, the quality of the data is bad. Data quality may be rated based on the specific business needs of the owner of the system. Different quality levels may be defined according to the amount of errors found in the data. For example, a numeric system may be used to rate the data qualities, such that the smaller the number, the better the quality of data. If data are within the specified error tolerance, then the data quality level is set to 1. If data are 20% outside of the specified error tolerance, then the data quality level is set to 2. If data are 40% outside of the specified error tolerance, then the data quality level is set to 3. And so on. This way, by looking at the data quality level ratings, users of the system may be able to determine how much errors are found in the data, with higher quality level numbers suggesting more errors and lower quality level numbers suggesting less errors. Optionally, determined Data Quality Metrics 212 may also be stored in the Quality Measurement Repository 210.

Depending on the types of data stored in the data warehouses 200, 201, 202, the Data Quality Measurement Rules 211 may include rules dealing with data gathered on hourly, daily, weekly, or monthly basis. The owner of the system may specify any time period for gathering the data depending on its business requirements. For example, there may be rules relating to daily page view numbers, daily link click numbers, weekly website visiting numbers, monthly sale numbers, etc. The daily-based rules may be applied to the corresponding daily type of data on a daily basis to determine the daily quality of the data. The weekly-based rules may be applied to the corresponding weekly type of data on a weekly basis to determine the weekly quality of the data. The monthly-based rules may be applied to the corresponding monthly type of data on a monthly basis to determine the monthly quality of the data. And so on. In other words, not all the Data Quality Measurement Rules 211 must be applied to all the data in the data warehouses 200, 201, 202 at the same time. A subset of the rules may be applied to a subset of the data at different times.

According to a specific embodiment, a Reporting Tool 220 is linked with the Quality Measurement Repository. The Reporting Tool 220 generates one or more data quality reports for the owner or users 240 of the system after the Data Quality Measurement Rules 211 are applied to the data in the data warehouses 200, 201, 202. Generally, new report(s) are generated each time the Data Quality Measurement Rules 211 are applied to the data in the data warehouses 200, 201, 202 to determine the Data Quality Metrics 212 of the data. Thus, reports may be generated on a daily, weekly, or monthly basis.

A report may include statistical information about the data for which qualities are measured. For example, a report may show the quality level for each type of data in the warehouses. The data may be sorted in terms of their quality levels so that users may easily identify what types of data have no error or less errors and what types of data are more problematic. Based on this information, users may narrow down, even pin point the probable causes of errors in those types of data, and fix the problems. For example, if reports show that one type of data consistently has the same kind of error, then the cause of the error is most likely due to an error within the system, such as a bug in the software. On the other hand, if reports show random errors for a type of data, then the cause of the error may be due to unexpected random events, such as human error or isolated incidents such that a server malfunction on a particular time.

The reports may be formatted and organized in such a way that it is easy for the users to retrieve relevant and useful information from reading the reports. For example, the measured data qualities may be represented in a metrics format and shown in a table format with columns and rows representing the types of data and their corresponding quality level respectively. The reports may be saved in a text file and Emailed to the users. Alternatively, the reports may be displayed as a web page, and the users may access them via the Internet using their web browsers. In other words, the methods of delivering the reports to the users depend on the specific needs of the users, perhaps chosen based on what the users consider as convenient and efficient. In fact, reports may be delivered in multiple methods, if necessary, to ensure that users receive the reports as soon as possible.

The reports may be delivered only to a list of subscribing or authorized users, such as system administrators or managers. A user subscribes to the system in order to receive the reports. The system maintains a list of subscribing users along with their contact information, such as their Email addresses, and the subscriber list may also be stored in the central repository. When new reports become available, they are only sent to those users on the subscribing list. For example, reports may be emailed only to those users on the subscribing list.

According to a specific embodiment, one may design and developing one's own custom reporting tool or integrate a commercial reporting tool software into the data quality measurement system. For example, MicroStrategy's MicroStrategy® software is such a reporting tool that may be integrated into the system.

Optionally, an Alerting Tool 230 alerts the owner or users 240 of the system when some data are bad, e.g., the data are not within the predefined error tolerance levels, so that the owner or users 240 may correct the problem(s) that have caused the errors in the data, or make any appropriate adjustments to the data quality measurement rules. The owner may specify certain conditions for the Alerting Tool 230 so that minor errors will not cause the Alerting Tool 230 to send out an alert. For example, if a type of data is outside of error tolerance range only once, then the Alerting Tool 230 will ignore it. On the other hand, if a type of data is consistently outside of error tolerance range over a period of time, then the Alerting Tool 230 will send out an alert. Alternatively, if the quality measurement rates that a type of data only contains small amount of errors—that is, the quality measurement level is below a certain predefined threshold, then the Alerting Tool 230 will ignore it, but if the quality measurement indicates that the type of data contains large amount of errors—that is, the quality measurement level is above the predefined threshold, then the Altering Tool 230 sends out an alert to the users. Of course, it is possible for the Alerting Tool 230 to send out an alert each and every time some type of data are not within its predefined error tolerance level. There are different methods to alert a user, such as sending an Email message, an instant message, a text message using the Short Message Service (SMS), etc.

Alternatively, the Alerting Tool 230 and the Reporting Tool 220 may be combined. In this case, alerts are raised, if necessary, along with the data quality reports. In other words, a single mechanism may both generate the reports and send out alerts.

According to a specific embodiment, one may develop and implement one's own customized version of the ETL process specifically to incorporate the data quality measurement procedures or modify a commercial ETL software, such as IBM's DataStage® or Oracle Warehouse Builder, by adding a component that enables the commercial ETL software to incorporate the data quality measurement rules.

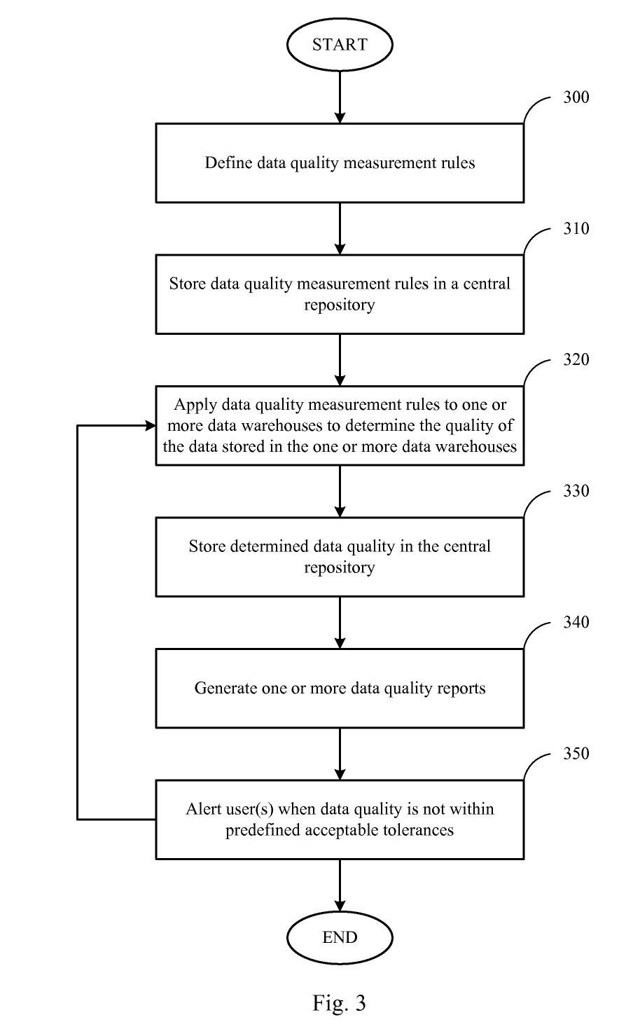

FIG. 3 is a flowchart of a method for maintaining the data quality of the data stored in one or more data warehouses within the framework of ETL processes. It is one of the methods of operating the system shown in FIG. 2.

At step 300, one or more data quality measurement rules are defined. At step 310, the defined data quality measurement rules are stored in a central repository. Steps 300 and 310 may be considered as preprocess. As described above in FIG. 2, the data quality measurement rules are defined based on the specific business needs and requirements of the individual entities. The rules are expressed using a data format that is appropriate and suitable for the type of repository used to store them. For example, if the central repository is a SQL-based database, then the data quality measurement rules may be expressed in SQL-based format. A user may manually enter the rules into the central repository through a standard SQL-based user interface. Alternatively, the rules may be stored in a file using a predefined syntax, and a software program may be used to parse the file to extract the rules and store them into the central repository.

According to one embodiment, the data quality measurement rules are expressed using a data quality metrics. The following is sample entries of one type of data quality metrics:
1. Page Views (Daily)-Compare with same day page views in previous week. (+/−5% tolerance)
2. Clicks to search/mail (Clicking cookies) (+/−5% tolerance)
3. Clicks to unknown (Position/Promotee) (+/−5% tolerance)
4. % of viewing cookies (For homepage set) (+/−5% tolerance)

At step 320, the data quality measurement rules are applied to data loaded into one or more data warehouses to determine the quality of the data stored therein. One way is to compare each type of data with respect to the corresponding predefined data quality measure rule for that type of data. If the data are within the acceptable range, then the quality of the data is good. If the data are not within the acceptable range, then the quality of the data is bad. At step 330, the determined data quality is stored in the central repository.

At step 340, one or more data quality reports are generated based on the determined data quality. Optionally, at step 350, the user(s) are alerted when the determined data quality is not within predefined acceptable tolerance levels.

According to a specific embodiment, steps 320, 330, 340, and 350 may be implemented as a software program, which include multiple functional modules that coordinate their functionalities with each other. For example, one module may include code for retrieving data quality measurement rules from the central repository, which may incorporate SQL code. Another module may include code for applying the retrieved quality measurement rules to the corresponding types of data stored in the data warehouses to measure the qualities of these data. Another module may store the measured data qualities in the central repository. The software program may be set as a batch process that is automatically executed periodically on a predefined schedule.

The following is a sample of pseudo code that may reflect one specific implementation of the software program:

```
for each type (T) of data stored in the data warehouse {
    retrieve data quality measurement rule for type T data (R_{T}) from the
central repository;
    retrieve type T data (D_{T}) from the data warehouse;
    compare D_{T} with R_{T} to determine the quality level of D_{T} (Q_{T});
    store Q_{T} in the central repository
}
generate a report that includes the quality level (Q_{T}) for
each type (T) of data;
```

Steps 320, 330, 340, and 350 may be repeated periodically or as the needs arise. For example, when new data are loaded into the data warehouses, their qualities need to be measured. Alternatively, when new data quality measurement rules become available, the qualities of the existing data in the data warehouses may be re-measured according to the new rules.

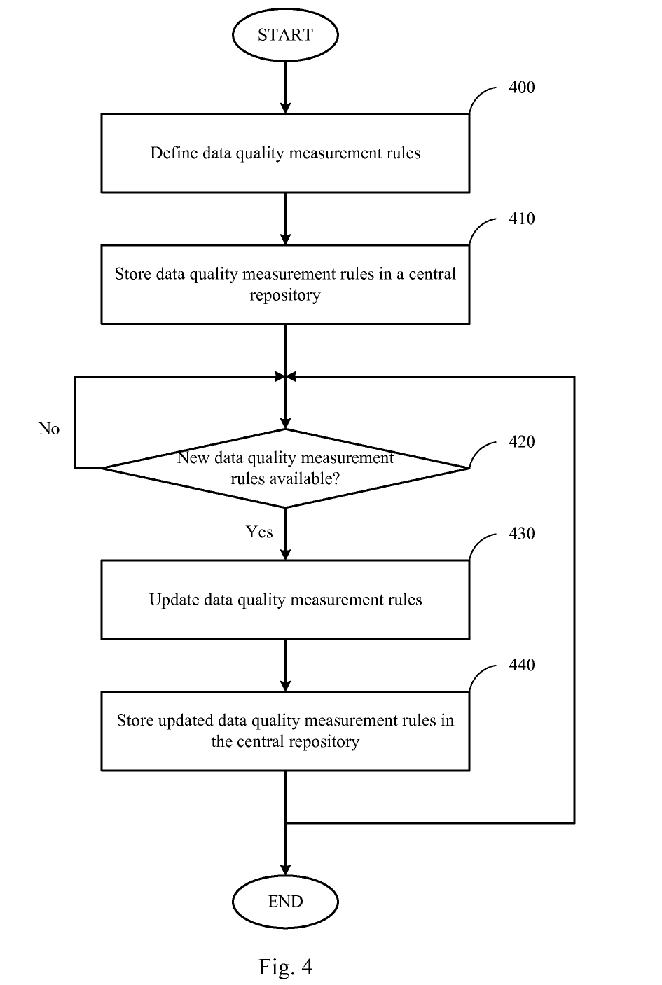

FIG. 4 is a flowchart of a method for updating data quality measurement rules in accordance with a specific embodiment of the invention. At step 400, one or more data quality measurement rules are defined. At step 410, the defined data quality measurement rules are stored in a central repository. Steps 400 and 410 may be considered as preprocess.

At step 420, a determination is made as to whether new data quality measurement rules are available. New data quality measurement rules may become available when the business needs or requirements change with time. New data quality measurement rules may also become available when various circumstances change for the business entities. For example, as a business grows with time, its products may become more popular and their sales increase. Assume a data quality measurement rule measures the monthly sale for each of the business' products; then, when a particular product's sales increase with time, its corresponding data quality measurement rule may be adjusted to reflect the increase in sales for that product.

If there are new data quality measurement rules, then at step 430, the data quality measurement rules are updated by replacing the old rules with the new rules. At step 440, the updated data quality measurement rules are stored in the central repository.

If there are no new data quality measurement rules, then no update is required. Steps 430, 430, and 440 may be repeated periodically or as the needs arise to update the data quality measurement rules when necessary.

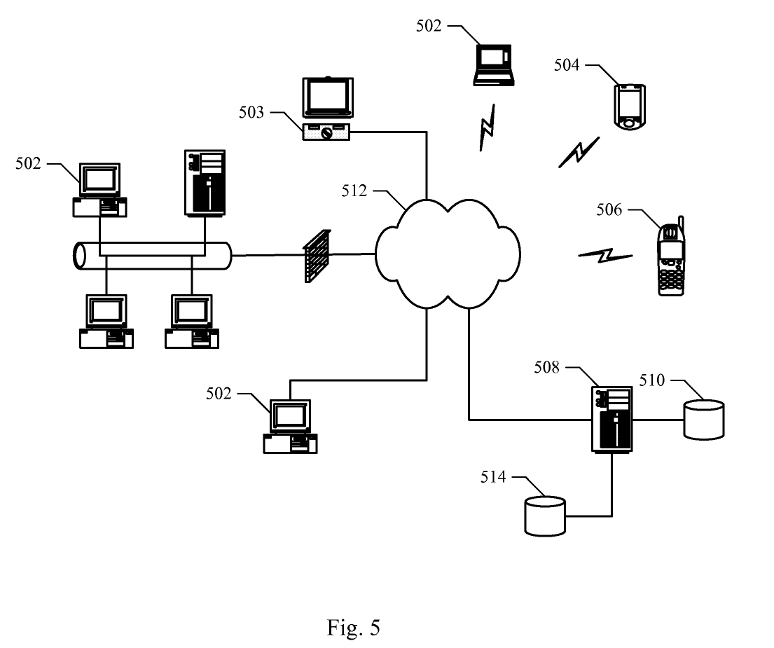

The methods described above in FIG. 3 and FIG. 4 may be carried out, for example, in a programmed computing system. FIG. 5 is a simplified diagram of a network environment in which specific embodiments of the present invention may be implemented. The various aspects of the invention may be practiced in a wide variety of network environments (represented by network 512) including, for example, TCP/IP-based networks, telecommunications networks, wireless networks, etc. In addition, the computer program instructions with which embodiments of the invention are implemented may be stored in any type of computer-readable media, and may be executed according to a variety of computing models including, for example, on a stand-alone computing device, or according to a distributed computing model in which various of the functionalities described herein may be effected or employed at different locations.

According to various embodiments, the ETL processes may gather data over the network environment 512. People may access the network using different methods, such as from computers 502 connected to the network 512 or from wireless devices 504, 506. Activities from these people generate data that may be gathered by the ETL process for future analysis. The ETL process may be executed on a server 508, and the transformed data are loaded into a data storage unit 510. Another data storage unit 512, also linked to the server, may be used as the central repository for storing the data quality measurement rules or the data quality measurement metrics and the measured data qualities.

The software program implementing various embodiments may be executed on the server. The reports may be emailed to the subscribing users via the network 512, and the users may view these reports at their computers 502. Urgent alerts that require immediate attention from the users may be sent as text messages to users' mobile telephone 506 using SMS or personal digital assistant (PDA) unit 504.

While this invention has been described in terms of several preferred embodiments, there are alterations, permutations, and various substitute equivalents, which fall within the scope of this invention. It should also be noted that there are many alternative ways of implementing the methods and apparatuses of the present invention. It is therefore intended that the following appended claims be interpreted as including all such alterations, permutations, and various substitute equivalents as fall within the true spirit and scope of the present invention.

What is claimed is:

1. A computer-implemented method for maintaining data quality of transformed data generated using an Extract-Transform-Load (ETL) process and stored in at least one data warehouse, the method comprising:
generating a quality metric for each of a plurality of units of the transformed data with reference to at least one data quality measurement rule, the quality metric for each unit of the transformed data representing a validity measure defined by the corresponding data quality measurement rule; and
generating a report organizing the quality metrics for selected units of the transformed data.

2. A computer-implemented method, as recited in claim 1, further comprising:
defining the at least one data quality measurement rule; and
storing the at least one data quality measurement rule in a repository.

3. A computer-implemented method, as recited in claim 2, further comprising:
updating the at least one data quality measurement rule stored in the repository.

4. A computer-implemented method, as recited in claim 2, further comprising:
after generating the quality metrics, storing the quality metrics in the repository; and
sending the report to a user.

5. A computer-implemented method, as recited in claim 1, further comprising:
alerting a user when at least one quality metric is not within a corresponding error tolerance defined by the corresponding data quality measurement rule.

6. A computer-implemented method, as recited in claim 1, further comprising:
generating the quality metrics for the units of the transformed data on a periodic basis; and
generating the report on the periodic basis,
wherein the periodic basis corresponds to one of a day, a week, or a month.

7. The computer-implemented method, as recited in claim 1, wherein the quality metric is one selected from a group consisting of a Boolean value indicating good and bad, and a rating number indicating a quality level.

8. The computer-implemented method, as recited in claim 1, further comprising:
performing business analysis on selected units of the transformed data for which the corresponding quality metrics indicate that those selected units of the transformed data contain no error.

9. A system for maintaining data quality of transformed data generated using an ETL process, comprising:
at least one data warehouse configured to store the transformed data;
a repository linked with each of the at least one data warehouse configured to store at least one data quality measurement rule and quality metrics, wherein each quality metric represents a validity measure defined by the corresponding data quality measurement rule for each of a plurality of units of the transformed data; and
a reporting mechanism linked with the repository configured to generate a report organizing the at least one quality metric for the transformed data.

10. A system, as recited in claim 9, further comprising:
an alerting mechanism linked with the repository configured to alert a user when at least one quality metric is not within a corresponding error tolerance defined by the corresponding data quality measurement rule,
wherein the at least one data quality measurement rule comprises at least one standard measure and at least one corresponding error tolerance for the transformed data.

11. A system, as recited in claim 9, wherein
there is one and only one repository in the system,
the repository is an SQL-based database, and
the at least one data quality measurement rule and the quality metrics are expressed in SQL format.

12. A system, as recited in claim 9, wherein the at least one data quality measurement rule comprises:
at least one daily data quality measurement rule used for determining daily quality metrics for a plurality of units of transformed daily data on a daily basis;
at least one weekly data quality measurement rule used for determining weekly quality for a plurality of units of transformed weekly data on a weekly basis; and
at least one monthly data quality measurement rule used for determining monthly quality for a plurality of units of transformed monthly data on a monthly basis.

13. A computer program product for maintaining data quality of transformed data generated using an Extract-Transform-Load (ETL) process and stored in at least one data warehouse, the computer program product comprising a computer-readable medium having a plurality of computer program instructions stored therein, which are operable to cause at least one computer device to:
generate a quality metric for each of a plurality of units of the transformed data with reference to at least one data quality measurement rule, the quality metric for each unit of the transformed data representing a validity measure defined by the corresponding data quality measurement rule; and
generate a report organizing the quality metrics for selected units of the transformed data.

14. A computer program product, as recited in claim 13, further comprising computer instructions to:
define the at least one data quality measurement rule; and
store the at least one data quality measurement rule in a repository.

15. A computer program product, as recited in claim 14, further comprising computer instructions to:
update the at least one data quality measurement rule stored in the repository.

16. A computer program product, as recited in claim 14, further comprising computer instructions to:
after generating the quality metrics, store the quality metrics in the repository; and
send the report to a user.

17. A computer program product, as recited in claim 13, further comprising computer instructions to:
alert a user when at least one quality metric is not within a corresponding error tolerance defined by the corresponding data quality measurement rule.

18. A computer program product, as recited in claim 13, further comprising computer instructions to:
generate the quality metrics for the units of the transformed data on a periodic basis; and
generate the report on the periodic basis,
wherein the periodic basis corresponds to one of a day, a week, or a month.

19. A computer program product, as recited in claim 13, wherein the quality metric is one selected from a group consisting of a Boolean value indicating good and bad, and a rating number indicating a quality level.

20. A computer program product, as recited in claim 13, further comprising computer instructions to:
performing business analysis on selected units of the transformed data for which the corresponding quality metrics indicate that those selected units of the transformed data contain no error.
